(19) United States
(12) Patent Application Publication
(10) Pub. No.: US 2006/0242110 A1
(43) Pub. Date: Oct. 26, 2006

(54) Methods and apparatus for accessing geospatial information

(75) Inventor: Hanoch (Nuke) Goldstein, Burlington, MA (US)

Correspondence Address: BEYER WEAVER & THOMAS, LLP, P.O. BOX 70250, OAKLAND, CA, 94612-0250, US

(73) Assignee: Carbon Project Incorporated

(21) Appl. No.: 11/114,920

(22) Filed: Apr. 25, 2005

(51) Int. Cl. G06F 17/30

(52) U.S. Cl. 707/1

(57) ABSTRACT

Methods and apparatus are provided for accessing geospatial information. A geospatial toolkit including source, handler, and data modules is configured to access geospatial data from a variety of sources, parse the geospatial data, and provide geospatial data in a unified format. Parameters including source, layer information, boundaries, query filters, etc. are set to allow retrieval of diverse geospatial data from different sources while providing a unified presentation on a system interface. The geospatial toolkit can be implemented in a framework such as the Component Object Module (COM) or NET framework.

### CROSS REFERENCE TO RELATED APPLICATIONS

The present application is related to concurrently filed U.S. patent application Ser. No. __/______ (Atty Docket No. CARBP001), titled METHODS AND APPARATUS FOR ACCESSING GEOSPATIAL INFORMATION by Hanoch (Nuke) Goldstein, the entirety of which is incorporated by reference for all purposes.

### BACKGROUND OF THE INVENTION

1. Field of the Invention

The present invention generally relates to accessing geospatial information. More specifically, techniques of the present invention provide portable tools for efficiently accessing a variety of geospatial information sources and providing the information to applications in a unified format.

2. Description of Related Art

Geospatial information is any data describing the location, characteristics, and/or features of a particular entity. Geospatial information is highly diverse and includes information from disparate sources such as terrain maps, aerial and satellite images, nautical charts, street maps, power grid data, transit route maps, and photographs. Components of geospatial information include addresses, coordinates, and identifiers.

A wide variety of applications use geospatial information. For example, photogrammetry applications use geospatial information in order to provide two dimensional or three dimensional measurements of an object. Resource development applications use geospatial information to discover and develop new oil and natural gas deposits. Power management applications use geospatial information to effectively route electricity in electric grids. Maritime applications use geospatial information to alert surface ships and submarines to maritime hazards.

The diversity of geospatial information has contributed to the diversity of sources of geospatial information. Many sources of geospatial information have developed their own specific and particular formats and media for maintaining the information. Geospatial information is stored on tape, disk, memory cards, in a wide range of specific and incompatible formats.

The increasing popularity of the Internet and the national and international need to share geospatial information in government and commercial systems has produced open specifications for geospatial information. However, mechanisms for accessing geospatial information remain limited, complicated, and resource intensive.

Organizations such as the Open Geospatial Consortium (OGC) have developed specifications for open geospatial web services including Web Map Server (WMS). WMS defines a common mechanism for interacting with a web service that provides data such as raster maps. Another specification by OGC, the Web Feature Service (WFS), provides geospatial data in the form of Geography Markup Language (GML). GML is an extension of the W3C Extensible Markup Language (XML) that supports geospatial information.

Nonetheless, geospatial information is generally robust and detailed. Consequently, the specifications provided by entities such as the OGC are generally voluminous, complicated, and detailed. In many instances, specifications provided by entities such as the OGC are abstract and difficult to implement. The complex nature of geospatial information also makes implementation of specifications difficult.

Application development complexity is increased because of the need to write detailed interfaces configured to access different types of geospatial data. Furthermore, each interface is typically data format specific. If a geospatial information format changes or if the developer wishes to access geospatial information from a different source, an application has to be rewritten or modified to accommodate the particularities of a new data format.

Techniques and mechanisms for providing open geospatial information and services to software developers are limited. For example, developers using a proprietary framework such as the NET and Component Object Module (COM) provided by Microsoft Corporation of Redmond, Wash. have limited access to tools and interfaces that allow efficient access to diverse geospatial information. Specifically, there are no software development toolkits for these frameworks that include software libraries that are not bound to a Geographic Information System (GIS) and are not dependent on any third party software. Consequently, there is a need for techniques and mechanisms that overcome the limitations associated with accessing geospatial information and implementing open geospatial applications in frameworks such as NET.

### SUMMARY OF THE INVENTION

Methods and apparatus are provided for accessing geospatial information. A geospatial toolkit including source, handler, and data modules is configured to access geospatial data from a variety of sources, parse the geospatial data, and provide geospatial data in a unified format. Parameters including source, layer information, boundaries, query filters, etc. are set to allow retrieval of diverse geospatial data from different sources while providing a unified presentation on a system interface. The interface is associated with a toolkit that internally handles complex open-geospatial standards and services and facilitates open-geospatial development for Windows applications, on platforms such as Component Object Module (COM) and .NET.

In one embodiment, a technique for accessing geospatial information services using an open-geospatial toolkit is provided. Multiple open geospatial web services comprising web map and web feature services are accessed. Geospatial information is obtained from the plurality of open geospatial web services. Geospatial information from the multiple open geospatial web services is parsed. Geospatial information is provided to a proprietary operating system and an associated framework.

A further understanding of the nature and advantages of the present invention may be realized by reference to the remaining portions of the specification and the drawings.

### BRIEF DESCRIPTION OF THE DRAWINGS

The invention may best be understood by reference to the following description taken in conjunction with the accompanying drawings, which are illustrative of specific embodiments of the present invention.

FIG. 1 is a diagrammatic representation showing usage of one example of an open-geospatial toolkit.

FIG. 2a is a diagrammatic representation showing components of an open-geospatial toolkit.

FIG. 2b is a diagrammatic representation showing a source-handler-data architecture supporting different sources of geospatial information.

FIG. 3a is a diagrammatic representation showing a source-handler-data architecture with multiple sources of geospatial information provided in a unified format.

FIG. 3b is a diagrammatic representation depicting a source-handler-data architecture with a single source of geospatial information provided in two different manners to a system interface.

FIG. 4 is a flow process diagram showing a technique for fetching and analyzing geospatial data.

FIG. 5 is a diagrammatic representation showing use of a geospatial toolkit in a Microsoft Windows operating environment.

FIG. 6 is diagrammatic representation depicting interaction between a user and a geospatial toolkit.

FIG. 7 is a diagrammatic representation showing a geospatial toolkit interacting with geospatial web-services within a NET framework.

FIG. 8 is a flow process diagram showing a technique for obtaining data from a geospatial information source.

### DETAILED DESCRIPTION OF SPECIFIC EMBODIMENTS

Reference will now be made in detail to some specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fibre channel networks. However, it should be noted that the techniques of the present invention can be applied to different variations and flavors of fibre channel. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Furthermore, techniques and mechanisms of the present invention will sometimes be described in singular form for clarity. However, it should be noted that some embodiments can include multiple iterations of a technique or multiple instantiations of a mechanism unless noted otherwise. For example, a processor is used in a variety of contexts. However, it will be appreciated that multiple processors can also be used while remaining within the scope of the present invention.

The advancement in computing hardware and software as well as the emergence of technologies such as the Internet are changing the field of Geographic Information Systems (GIS). The movement toward a more distributed and mobile society and the need to utilize and share geospatial information and services has produced an effort by organizations such as the World Wide Web Consortium (W3C) and Open Geospatial Consortium (OGC) to develop a common ‘language’ that will allow access to and distribution of geospatial information.

Conventionally, most geospatial information was managed by different vendors in numerous forms and formats. Numerous proprietary formats were used to support maps, features and other geospatial information. Having numerous formats creates a major problem when tackling the task of information sharing between systems and organizations. Some conventional commercial solutions cope with the task of transporting information from one vendor to another by providing solutions that support numerous formats and can translate one format to another format. However, conventional solutions are limited in many ways. For example, support of formats is bound to data sources the tool is designed to work with, and the introduction of a new version or an unsupported data format can not be handled without updates of modifications to the software tools. Furthermore, translation tools may be very complicated, resource intensive and software heavy solutions that are susceptible to specification implementation errors by the solution provider. In addition, some vendors may choose not to publish their proprietary specifications, thus preventing other parties from supporting their geospatial information formats.

Consequently, the techniques and mechanism of the present invention provide tools to allow a user to efficiently and effectively access a variety of geospatial information sources. According to various embodiments, a system interface such as an Application Programming Interface (API) is provided to hide the complexity of these services, allowing a user to access and use multiple geospatial services through a unified set of methods and properties through Microsoft technologies such as the .NET framework.

In one embodiment, a unified interface is provided through a portable and detachable geospatial interface for software development. The interface is associated with a toolkit that hides the complexity of open geospatial web services and facilitates open geospatial development for Windows applications, including the NET Framework. The toolkit includes software libraries that are not bound to any specific Geographic Information System (GIS) and are not dependent on any third party software. In one example, the toolkit is based on the Microsoft NET or COM framework.

According to various embodiments, the toolkit is implemented using an architecture developed to handle geospatial data from a variety of sources. The toolkit includes a source-handler-data architecture. Each geospatial service or source is handled using three main modules. The source module handles the information needed to access the data source. The handler module manages the interaction with the data source and stores the geospatial information into a data component. The data module stores and manages data objects. The source-handler-data architecture allows access to a variety of supported data sources in a variety of formats. The architecture allows processing of the information and maintenance of the stored data. Using the source-handler-data architecture, the techniques of the present invention provide mechanisms to describe a separation between the data source and the data content.

The separation of source and content allows handling of different sources in a unified data management system. For example, one data source may be a web service that returns raster maps while another source may be a file that points to some spatial data and a map image file. The two sources have a common data type but completely different providers. Another example involves two different handlers that can access information from a single data source and store the information in different data components (database, file, memory block etc.). According to various embodiments, the architecture calls for a handler component that manages the interaction with the source, the management of the imported data and storage of the parsed data. By using a source-handler-data architecture, developers can efficiently access geospatial information from a variety of sources and store and manage the information for application use by using discrete, interoperable components.

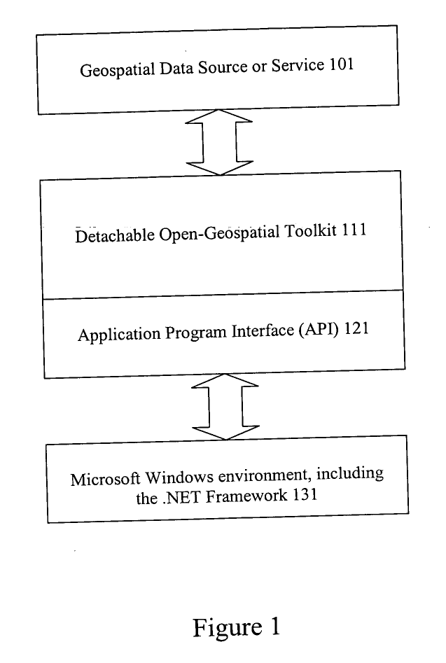

FIG. 1 is a diagrammatic representation showing usage of an open-geospatial toolkit system architecture. According to various embodiments, the detachable open geospatial toolkit 111 provides a platform for easily developing geospatial applications. The open geospatial toolkit 111 is associated with a unified application program interface 121. The unified application program interface 121 allows efficient development in an environment such as Microsoft Windows using a framework such as NET 131. The open geospatial toolkit 111 allows a developer to obtain data from a variety of geospatial data sources or services 101. According to various embodiments, the toolkit 111 provides a way to interact with any Web Map Service (WMS), Web Feature Service (WFS) or Geography Markup Language (GML). The toolkit 111 provides a sophisticated parser to deal with the complexities of geospatial information through an open API and a versatile feature data module. The toolkit 111 can be expanded to support additional data formats with the simple addition of components or modules into the toolkit 111.

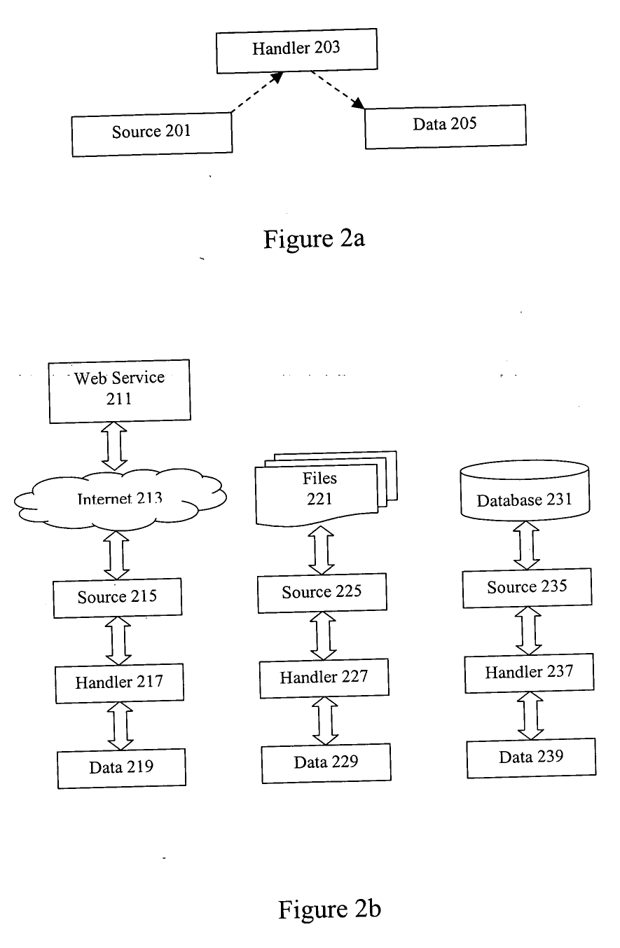

FIG. 2a is a diagrammatic representation showing components of an open geospatial toolkit system architecture. According to various embodiments, a toolkit includes a source module 201, a handler module 203, and a data module 205. The source module 201 handles the information needed to access the data source. The handler module 205 manages the interaction with the data source and stores the geospatial information into a data component. The data module 205 stores and manages geospatial information in data objects. If additional sources of data are developed, a toolkit can be modified by simply adding additional modules to handle different types of data. In some embodiments, no other modifications are needed as updates to a toolkit are modular and component-based.

FIG. 2b is a diagrammatic representation showing a source-handler-data architecture supporting different sources of geospatial information. A source module 215 is coupled to handler module 217. The handler module 217 is coupled to the data module 219. The source module 215 is connected to access geospatial information from a web service 211 over a network such as the Internet 213. A source module 225 is coupled to handler module 227. The handler module 227 is coupled to the data module 229. The source module 225 is connected to access geospatial information from geospatial information files 221. The data in files 221 may be provided in a different format than data provided by web service 211. Another source module 235 is coupled to handler module 237. The handler module 237 is coupled to the data module 239. The source module 235 is connected to access geospatial information from a database 231. The geospatial information in database 231 may again be different than the than the information in files 221 or web service 211.

The techniques of the present invention allow separation between the data source and the data content. The separation allows handling of different sources in a unified data management system. For example, one data-source may be a web-service that returns raster maps while another source may be a file that points to some spatial data and a map image file. The two sources may have a common data type, such as raster map data, but completely different providers. The architecture includes a handler component that manages interaction with the source and also controls the transfer, parsing, and storage of data.

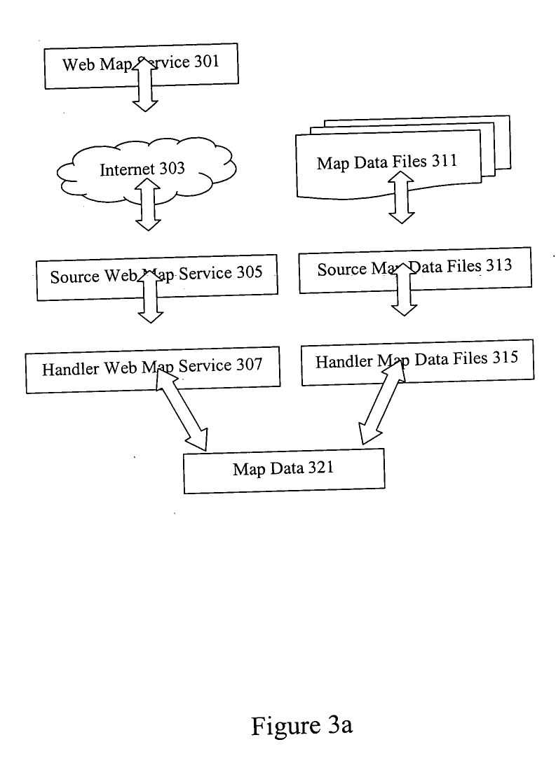

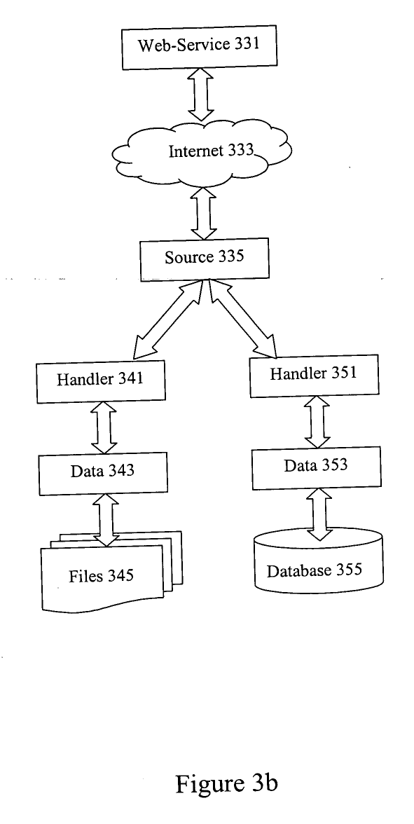

FIG. 3a is a diagrammatic representation showing a source-handler-data architecture depicting different sources of geospatial information provided into a single data component. Source web map service module 305 accesses data from web map service 301 through the Internet 303. The source web map service 305 is connected to handler web map service module 307. Source map data files module 313 accesses data from map data files 311. The source map data files module 313 is connected to handler map data files module 315. Both the handler web map service module 307 and the handler map data files module 315 are connected to map data module 321. By using a single map data module 321, the data accessed from multiple sources can be provided to an application developer in a unified format. Any single format that can hold geospatial information from multiple geospatial information sources is referred to herein as a unified format.

FIG. 3b is a diagrammatic representation showing a source-handler-data architecture with a single source of geospatial information provided in two different manners to a system interface. Source module 335 accesses data from a web service 331 through the Internet 333. The source module 335 is connected to two different handlers 341 and 351. According to various embodiments, the two different handlers 341 and 351 are associated with different parsing mechanisms. Handler component 341 is connected to data module 343 associated with files 345 and handler 351 is connected to data module 353 associated with database 355.

Although source modules, handler modules, and data modules can be implemented in a variety of manners, the techniques of the present invention contemplate implementing them as portable, self-contained modules using the NET framework. According to various embodiments, the toolkit and the source, handler, and data modules are implemented using base modules.

In one particular example, base modules include a Tools.Core.Base module that provides the essentials of a source-handler-data. This module includes the basic building blocks for the architecture including interfaces that define data sources, handlers and data types. A Tools.Core.Geometries module provides basic handling of geometries such as point, line, and polygon. In addition, geometry collection classes are provided under this namespace. A Tools.Core.Features module provides sophisticated data and metadata capabilities. This module can support a nested metadata model with embedded multiple geometries (through the geometries module) per feature. The robust nature of this data is simplified with analysis tools provided by the feature analysis class. This class provides tools to find and access information within complex data structures. A Tools.Core.Drawing module provides techniques to render data objects into a drawing surface, such as a bitmap. This module includes a default rendering functionality along with the ability to customize and extend the functionality with user defined extensions.

In this example, the Tools.Core.OGCCapabilities module provides handler, source, and data components for obtaining and parsing the service capabilities of any Web Map Server (WMS) or Web Feature Service (WFS). This module can handle the interaction with the service in a multi-threaded (a-synchronous) way. The data module (DataOGCCapabilities) provides an extensive breakdown of XML file capabilities. The Tools.Core.GML module provides geospatial markup language (GML) parsers. This module includes two parser utilities for GML. The Validating parser uses schemas to analyze the GML data and supports sophisticated GML files. The Fast parser uses common implementations of GML without the use of a schema and is faster than the Validating parser. The Tools.Core.WFS module provides source and handler components for accessing any Web Feature Service (WFS) and Geography Markup Language (GML).

GML is parsed and stored in a DataFeatures module using GML parsers. This module can handle the interaction with the WFS in a multi threaded (asynchronous) way. The Tools.CoreWMS module provides source and handler components for accessing and handling any Web Map Service (WMS). Raster maps are stored in the DataRaster base module. This module can handle the interaction with the WMS in a multi-threaded (asynchronous) manner. The ToolsCore.PictureBoxOGC extends the NET System.Windows.FormsPictureBox control by providing properties to read and display data from WMS or WFS. Most of the control's functionality can be tested while in the Microsoft Visual Studio NET designer mode, without any need for source code changes.

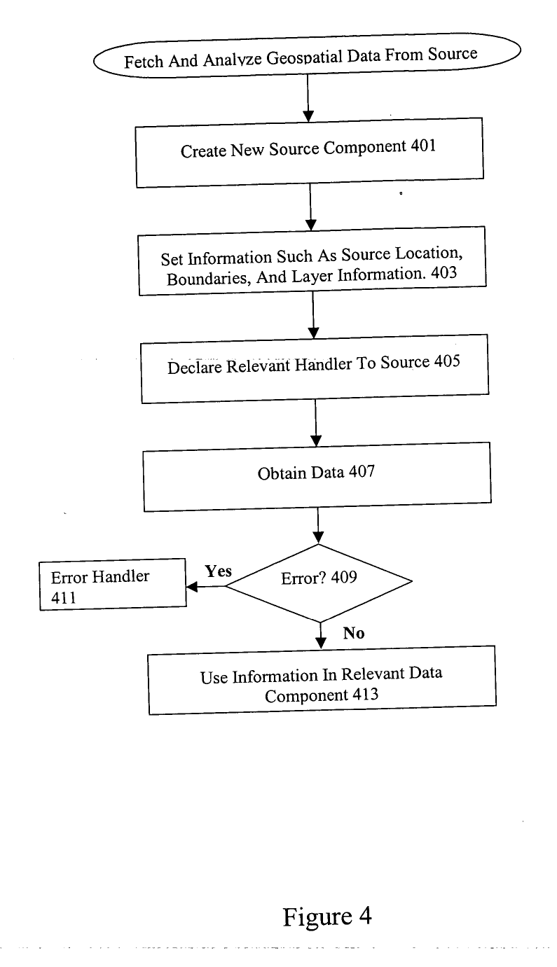

FIG. 4 is a flow process diagram showing a technique for fetching and analyzing geospatial data. At 401, a new source component is created. According to various embodiments, the new data source component created corresponds to the type and format of the data from the geospatial data source. At 403, information such as source location, boundaries, and layer information are set. In some embodiments, parameters, such as boundaries are set to determine the portion or amount of geospatial data to acquire. For example, two or three dimensional boundaries may be set for information obtained from nautical charts. Boundaries may be provided using coordinates, vectors, or any other mechanism for identifying a portion of geospatial information. Layer information may be used to depict the layer of a particular map to obtain. For example, one layer may include all roads and bridges, while another layer may include only highways. Another layer may include information on points of interest. At 405, the relevant handler is declared to the source. In one example, a handler module is associated with a source module. At 407, the data is obtained. At 409, it is determined if any errors are present. If an error occurs, an error handling mechanism is executed at 411. Otherwise, information is used in the relevant data component at 413.

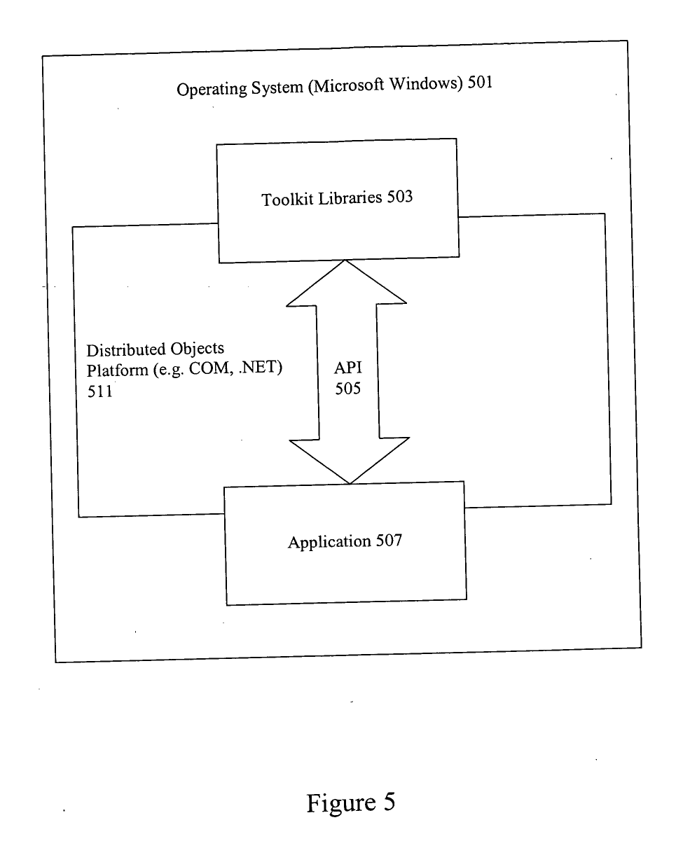

FIG. 5 is a diagrammatic representation showing use of a geospatial toolkit in a Microsoft Windows operating environment. Application 507 accesses a geospatial toolkit 503 using an Application Programming Interface (API) 505. The toolkit 503 and the API 505 are provided in a distributed objects platform framework such as COM or NET. Providing a toolkit using a framework such as COM or NET allows more efficient development of geospatial applications. A unified API 505 is provided even if data sources are diverse and varied. The software developer can access parsed geospatial information using methods that allow inspection of data, data properties, and metadata. In typical implementations, the developer does not need to know how to fetch the data and how to parse and process the data. The geospatial toolkit transforms the problem into describing where to get the data and analyzing the processed information.

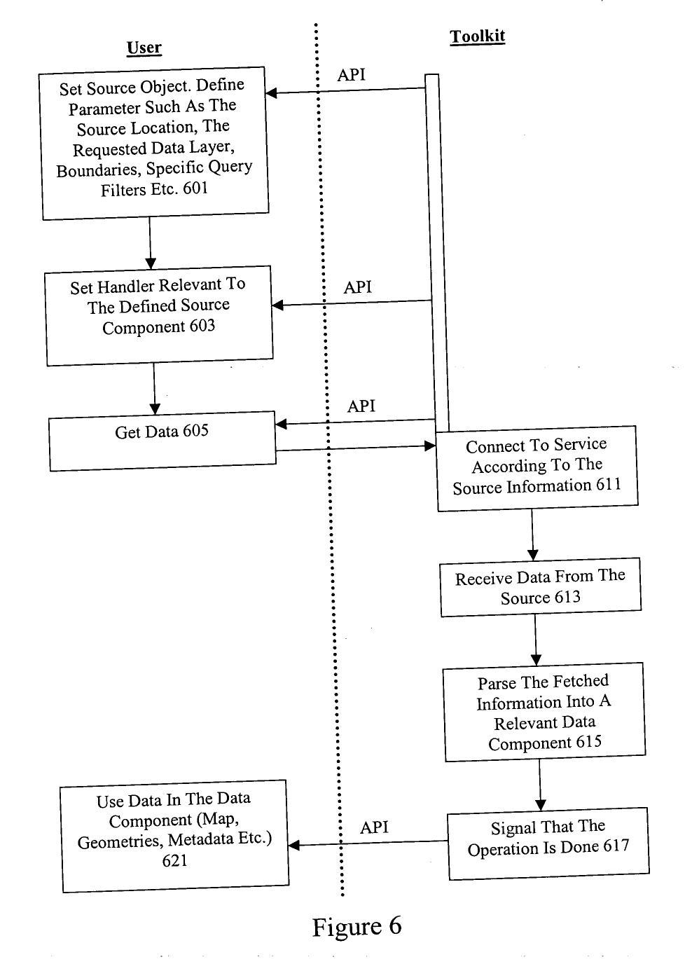

FIG. 6 is a diagrammatic representation showing interaction between a user and a geospatial toolkit. At 601, the user or user application sets a source object. According to various embodiments, the user defines parameters such as the source location, the requested data layer, specific query filters, boundaries, and coordinates. In some embodiments, the user sets parameters using an API provided by a geospatial toolkit. At 603, a handler relevant to the defined source component is defined. The handler is again defined using an API provided by the geospatial toolkit. According to various embodiments, different handlers are provided for different source components. At 605, a request to obtain the data is made by the user. In one example, the geospatial toolkit receives the request and 611 and connects to the service according to the source information defined by the user.

At 613, data is received from the source by the geospatial toolkit. At 615, the data is parsed into a relevant data component 615. At 617, the geospatial toolkit signals that the operation is done. Upon obtaining the signal, the application uses the data in the data component without having to parse or process the data content. The data in the data component may include map portions, geometries, metadata, etc. It should be noted that reading and analyzing the geospatial information can be done either in a single or multi-threaded manner. The application program interface allows multi-threaded operations using events and callbacks.

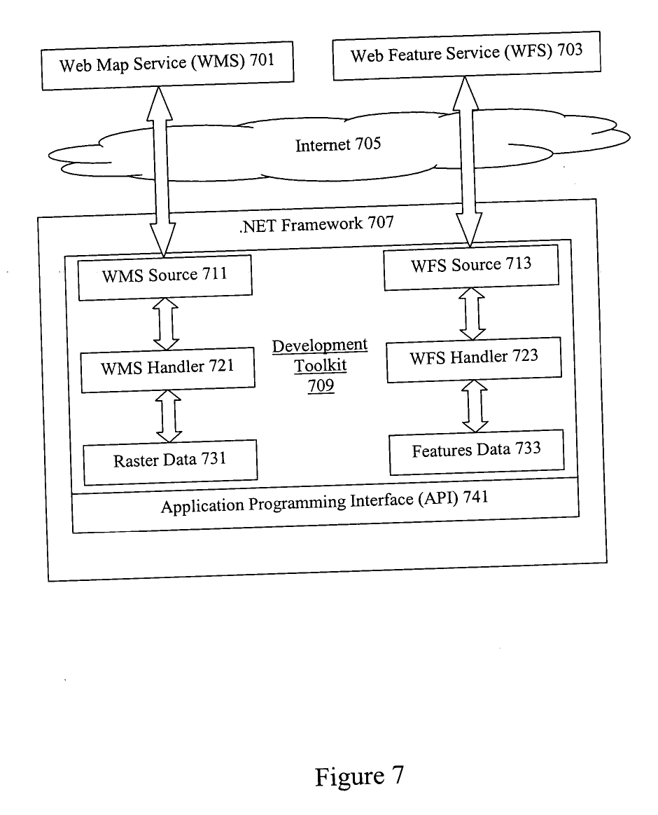

FIG. 7 is a diagrammatic representation showing a geospatial toolkit. The geospatial toolkit 709 includes source components, handler components, and data components. In one example, the geospatial toolkit 709 includes a Web Map Service (WMS) source component 711 configured to obtain data from a Web Map Service 701 over the Internet 705. The geospatial toolkit 709 also includes a Web Feature Service (WFS) component 713 configured to access a Web Features Service 703 over the Internet 705. The WMS source 711 is coupled to a WMS handler 721. The WMS handler 721 takes data from the WMS source and parses and processes the data to allow data component 731 to provide raster data.

Similarly, a Web Feature Service (WFS) source component 713 is configured to obtain data from a Web Feature Service 703 over the Internet 705. The geospatial toolkit 709 also includes a Web Feature Service (WFS) component 713 configured to access a Web Features Service 703 over the Internet 705. The WFS source 713 is coupled to a WFS handler 723. The WFS handler 723 takes data from the WFS source and parses and processes the data to allow features data component 733 to provide feature data. Components are implemented within a Microsoft NET framework 707, the unified interface instead of APIs 741 is provided to users and developers.

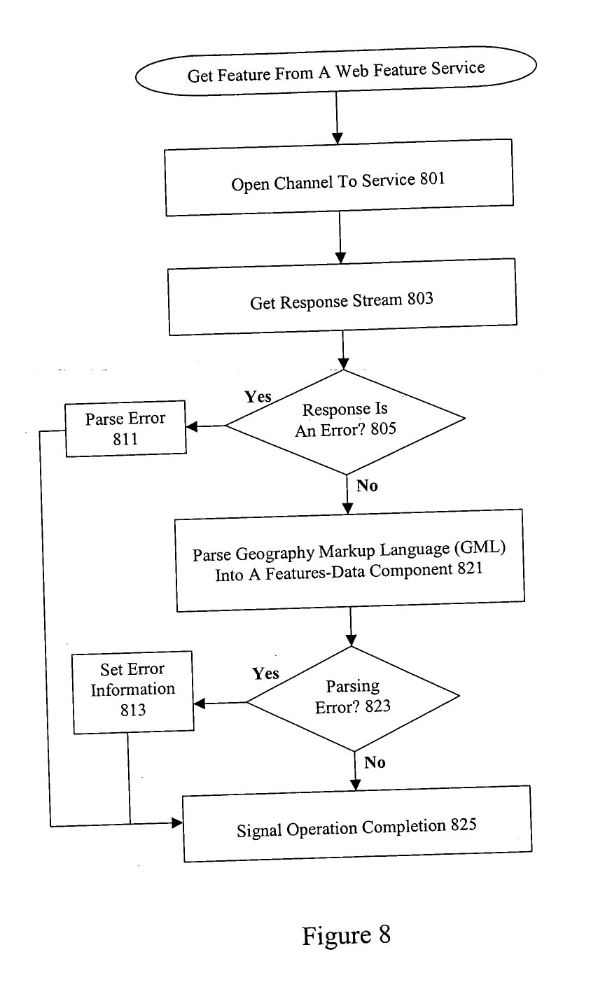

FIG. 8 is a flow process diagram showing a technique for obtaining data from a geospatial information source. In one example, the source component is obtaining a feature from a Web Feature Service. At 801, the source component opens a channel to the service. In some examples, the channel may be a connection to a web service, but it may also be a connection to a database or a handle to a file. At 803, a response stream is obtained. At 805, it is determined if the response is an error. If the response is an error, the error is parsed at 811 to provide error information. If the response is not an error at 805, information such as Geography Markup Language (GML) information is parsed into a features data component at 821. At 823, it is determined if there is a parsing error. If a parsing error has occurred, error information is set at 813. Operation completion is signaled at 825.

The techniques and mechanisms of the present invention can be implemented in a computer system having one or more processors. In one embodiment, the computer system includes one or more processors, memory, and a network interface allowing the computer system to communicate with external entities such as geospatial information servers. The techniques and mechanisms of the present invention can be implemented in a wide variety of computer system configurations. For instance, instructions and data for implementing the above-described invention may be stored on a disk drive, a hard drive, a floppy disk, a server computer, or a remotely networked computer.

While the invention has been particularly shown and described with reference to specific embodiments thereof, it will be understood by those skilled in the art that changes in the form and details of the disclosed embodiments may be made without departing from the spirit or scope of the invention. For example, embodiments of the present invention may be employed with a variety of network protocols and architectures. Accordingly, the present embodiments are to be considered as illustrative and not restrictive, and the invention is not to be limited to the details given herein, but may be modified within the scope and equivalents of the appended claims.

What is claimed is:

1. A method for accessing geospatial information services using an open-geospatial toolkit, the method comprising:
accessing a plurality of open geospatial web services comprising web map and web feature services;
obtaining geospatial information from the plurality of open geospatial web services;
parsing geospatial information from the plurality of open geospatial web services;
providing geospatial information to a proprietary operating system and an associated framework.

2. The method of claim 1, wherein the open-geospatial toolkit includes generic software libraries applicable to a plurality of Geographic Information Systems (GIS).

3. The method of claim 1, wherein the proprietary operating system is a Microsoft Windows operating system.

4. The method of claim 3, wherein the associated application framework is the NET framework.

5. The method of claim 3, wherein the associated application framework is a Component Object Module (COM) framework.

6. The method of claim 1, further comprising creating a new data source component.

7. The method of claim 6, further comprising setting geospatial data source information.

8. The method of claim 1, wherein geospatial information is parsed into a data component.

9. The method of claim 8, wherein data in the data component comprises maps, geometries, and metadata.

10. The method of claim 1, wherein geospatial information is obtained from a web map service (WMS).

11. The method of claim 1, wherein geospatial information is obtained from a web feature service (WFS).

12. The method of claim 1, wherein geospatial information is obtained from a Geography Markup Language (GML) source.

13. A computer program product including computer code for accessing geospatial information services using an open-geospatial toolkit, the computer program product comprising:
computer code for accessing a plurality of open geospatial web services comprising web map and web feature services;
computer code for obtaining geospatial information from the plurality of open geospatial web services;
computer code for parsing geospatial information from the plurality of open geospatial web services;
computer code for providing geospatial information to a proprietary operating system and an associated framework.

14. The computer program product of claim 13, wherein the open-geospatial toolkit includes generic software libraries applicable to a plurality of Geographic Information Systems (GIS).

15. The computer program product of claim 13, wherein the proprietary operating system is a Microsoft Windows operating system.

16. The computer program product of claim 15, wherein the associated application framework is the NET framework.

17. The computer program product of claim 15, wherein the associated application framework is a Component Object Module (COM) framework.

18. The computer program product of claim 13, further comprising creating a new data source component.

19. The computer program product of claim 18, further comprising setting geospatial data source information.

20. A computer system for accessing geospatial information services using an open-geospatial toolkit, the computer system comprising:
means for accessing a plurality of open geospatial web services comprising web map and web feature services;
means for obtaining geospatial information from the plurality of open geospatial web services;
means for parsing geospatial information from the plurality of open geospatial web services;
means for providing geospatial information to a proprietary operating system and an associated framework.
